(19) United States
(12) Patent Application Publication
(10) Pub. No.: US 2024/0013706 A1
(43) Pub. Date: Jan. 11, 2024

(54) LED PANEL AND DRIVING METHOD THEREOF

(71) Applicant: TCL CHINA STAR OPTOELECTRONICS TECHNOLOGY CO., LTD., Guangdong (CN)

(72) Inventor: Haoran LI, Shenzhen (CN)

(21) Appl. No.: 17/295,450

(22) PCT Filed: Apr. 13, 2021
(86) PCT No.: PCT/CN2021/086818

§ 371 Date: Oct. 13, 2022

(30) Foreign Application Priority Data
Apr. 8, 2021 (CN) 202110376085.3

(51) Int. Cl. G09G 3/32

(52) U.S. Cl. CPC G09G 3/32; G09G 2330/021; G09G 2310/08

(57) ABSTRACT

A light-emitting diode (LED) panel and a driving method thereof are disclosed. The LED panel includes a clock generation module configured to provide a clock signal; a control module including a plurality of output terminal groups, wherein, each of the output terminal groups includes at least one first output terminal, and the control module is configured to output electrical signals through different output terminal groups in sequence in a same frame time according to the clock signal; and a plurality of LED modules, wherein, each of the LED modules is correspondingly connected to the at least one first output terminal by one to one, and the LED modules are configured to emit light in sequence according to the electrical signals.

### FIELD OF INVENTION

The present disclosure relates to the field of display technologies, and more particularly, to an LED panel and a driving method thereof.

### BACKGROUND OF INVENTION

During research and practice of current technology, the inventor of the present application finds that in sub-millimeter light-emitting diode (mini-LED) panels and micro-light-emitting diode (micro-LED) panels, driving chips are needed to drive LEDs to emit light. However, in the current technology, each driving chip needs a decoupling capacitor of at least 0.1 uF to provide a stable VDD voltage to the driving chips. Addition of this capacitor increases costs and reduces a luminous effect of whole device.

Technical problem: an embodiment of the present disclosure provides an LED panel and a driving method thereof, which can omit the decoupling capacitor, reduce the costs, and improve the luminous effect of whole device.

### SUMMARY OF INVENTION

An embodiment of the present disclosure provides a light-emitting diode (LED) panel, which includes:

a clock generation module configured to provide a clock signal;

a control module connected to the clock generation module, wherein, the control module includes a plurality of output terminal groups, each of the output terminal groups includes at least one first output terminal, and the control module outputs electrical signals through different output terminal groups in sequence in a same frame time according to the clock signal; and

a plurality of LED modules, wherein, each of the LED modules is correspondingly connected to the at least one first output terminal by one to one, and the LED modules are configured to emit light in sequence according to the electrical signals.

Optionally, in some embodiments of the present disclosure, the control module includes a logic control unit and a plurality of conversion units, and each of the conversion units includes at least one conversion submodule;

the logic control unit is connected to the clock generation module and includes a plurality of second output terminals, at least one of the second output terminals is correspondingly connected to one of the conversion units, each of the conversion units is correspondingly connected to one of the output terminal groups, and the at least one conversion submodule is correspondingly connected to the at least one first output terminal by one to one;

the logic control unit is configured to output digital signals to the conversion units through the at least one of the second output terminals in the same frame time according to the clock signal; and

the conversion units are configured to convert the digital signals into the electrical signals and output the electrical signals to the LED modules through the at least one first output terminal of each of the output terminal groups.

Optionally, in some embodiments of the present disclosure, each of the output terminal groups includes one first output terminal, each of the conversion units includes one conversion submodule, each of the second output terminals of the logic control unit is correspondingly connected to the conversion submodule of each of the conversion units, and the conversion submodule of each of the conversion units is correspondingly connected to one of the LED modules through the first output terminal of each of the output terminal groups.

Optionally, in some embodiments of the present disclosure, each of the output terminal groups includes a plurality of first output terminals, each of the conversion units includes a plurality of conversion submodules, each of the second output terminals of the logic control unit is correspondingly connected to one of the conversion submodules, and each of the conversion submodules is correspondingly connected to one of the LED modules through one of the first output terminals.

Optionally, in some embodiments of the present disclosure, each of the output terminal groups includes a plurality of first output terminals, each of the conversion units includes a plurality of conversion submodules, each of the second output terminals of the logic control unit is correspondingly connected to the conversion submodules, and each of the conversion submodules is correspondingly connected to one of the LED modules through one of the first output terminals.

Optionally, in some embodiments of the present disclosure, in a turned-on stage of the LED panel, the logic control unit outputs the digital signals to a next conversion unit in sequence by delaying a setting time.

Optionally, in some embodiments of the present disclosure, the setting time ranges from 100 ns to 2500 ns.

Optionally, in some embodiments of the present disclosure, the logic control unit outputs the digital signals to different conversion units in sequence by delaying a same setting time or different setting times.

Optionally, in some embodiments of the present disclosure, each of the LED modules includes an LED device group, a switching device, and a ground wire, the at least one conversion submodule is connected to a control terminal of the switching device by the at least one first output terminal, an input terminal of the switching device is connected to the LED device group, and an output terminal of the switching device is connected to the ground wire.

Optionally, in some embodiments of the present disclosure, the switching device is a constant-current field effect transistor.

Optionally, in some embodiments of the present disclosure, the LED panel further includes a power supply module connected to an input terminal of each of the LED modules.

Correspondingly, an embodiment of the present disclosure further provides a driving method of a light-emitting diode (LED) panel, wherein, the LED panel includes a clock generation module, a control module, and a plurality of LED modules, the control module is connected to the clock generation module and includes a plurality of output terminal groups, each of the output terminal groups includes at least one first output terminal, and each of the LED modules is correspondingly connected to the at least one first output terminal by one to one; the driving method includes following steps:
step B1: the clock generation module providing a clock signal;
step B2: in a same frame time, the control module outputting electrical signals through different output terminal groups in sequence according to the clock signal; and
step B3: the LED modules emitting light in sequence according to the electrical signals.

Optionally, in some embodiments of the present disclosure, the control module includes a logic control unit and a plurality of conversion units, and each of the conversion units includes at least one conversion submodule;
the logic control unit is connected to the clock generation module and includes a plurality of second output terminals, at least one of the second output terminals is correspondingly connected to one of the conversion units, each of the conversion units is correspondingly connected to one of the output terminal groups, and the at least one conversion submodule is correspondingly connected to the at least one first output terminal by one to one;
wherein, the step B2 includes following steps:
step B21: in the same frame time, the logic control unit outputting digital signals to the conversion units through the at least one of the second output terminals according to the clock signal; and
step B22: the conversion units converting the digital signals into the electrical signals and outputting the electrical signals to the LED modules through the at least one first output terminal of each of the output terminal groups.

Optionally, in some embodiments of the present disclosure, each of the output terminal groups includes one first output terminal, each of the conversion units includes one conversion submodule, each of the second output terminals of the logic control unit is correspondingly connected to the conversion submodule of each of the conversion units, and the conversion submodule of each of the conversion units is correspondingly connected to one of the LED modules through the first output terminal of each of the output terminal groups.

Optionally, in some embodiments of the present disclosure, the step B21 includes a following step: in the same frame time of a turned-on stage of the LED panel, the logic control unit outputting the digital signals to a next conversion unit through the at least one of the second output terminals in sequence according to the clock signal by delaying a setting time.

Optionally, in some embodiments of the present disclosure, the setting time ranges from 100 ns to 2500 ns.

Optionally, in some embodiments of the present disclosure, the step B21 includes a following step: the logic control unit outputting the digital signals to different conversion units through the at least one of the second output terminals in sequence according to the clock signal by delaying a same setting time or different setting times.

Optionally, in some embodiments of the present disclosure, each of the LED modules includes an LED device group, a switching device, and a ground wire, the at least one conversion submodule is connected to a control terminal of the switching device by the at least one first output terminal, an input terminal of the switching device is connected to the LED device group, and an output terminal of the switching device is connected to the ground wire.

Optionally, in some embodiments of the present disclosure, the switching device is a constant-current field effect transistor.

Optionally, in some embodiments of the present disclosure, the LED panel further includes a power supply module connected to an input terminal of each of the LED modules.

Beneficial effect: in the same frame time, the control module of the embodiments of the present disclosure outputs the electrical signals to different LED modules through different output terminal groups in sequence. Since the control module outputs the electrical signals in sequence by delaying the setting time, it can prevent all of the LED modules from being turned on at a same time and can reduce an instantaneous current load of the LED panel to maintain normal operations of the control module.

### DESCRIPTION OF DRAWINGS

The accompanying figures to be used in the description of embodiments of the present disclosure will be described in brief to more clearly illustrate the technical solutions of the embodiments. The accompanying figures described below are only part of the embodiments of the present disclosure, from which those skilled in the art can derive further figures without making any inventive efforts.

FIG. 1 is a schematic structural diagram of an LED panel according to an embodiment of the present disclosure.

FIG. 2 is another schematic structural diagram of the LED panel according to an embodiment of the present disclosure.

FIG. 3 is yet another schematic structural diagram of the LED panel according to an embodiment of the present disclosure.

FIG. 4 is a flowchart of a driving method of the LED panel according to an embodiment of the present disclosure.

### DETAILED DESCRIPTION OF PREFERRED EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative efforts are within the scope of the present disclosure. In addition, it should be understood that the specific embodiments described herein are only used to illustrate and explain the present disclosure, and are not used to limit the present disclosure. In the present disclosure, in the case of no explanation to the contrary, the orientation words used such as “on” and “under” usually refer to upper and lower directions of the device in actual use or working state, and specifically the directions in the drawings; and “inside” and “outside” refer to the outline of the device.

The embodiments of the present disclosure provide a light-emitting diode (LED) panel and a driving method thereof, which will be described in detail below. It should be noted that an order of description in the following embodiments is not meant to limit a preferred order of the embodiments.

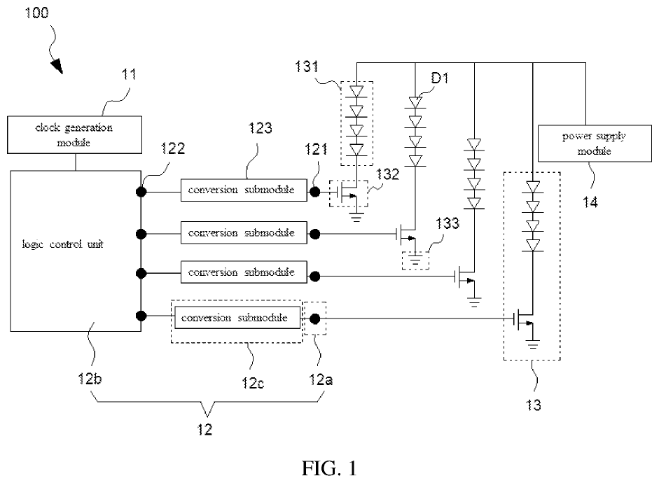

Referring to FIG. 1, an embodiment of the present disclosure provides the LED panel 100, which includes a clock generation module 11, a control module 12, a plurality of LED modules 13, and a power supply module 14.

The clock generation module 11 is configured to provide a clock signal.

The control module 12 is connected to the clock generation module 11. The control module 12 includes a plurality of output terminal groups 12a, and each of the output terminal groups 12a includes at least one first output terminal 121. The control module 12 is configured to output electrical signals through different output terminal groups 12a in sequence in a same frame time according to the clock signal.

Each of the LED modules 13 is correspondingly connected to one first output terminal 121. The LED modules 13 are configured to emit light in sequence according to the electrical signals.

The power supply module 14 is connected to the LED modules 13. The power supply module 14 provides a constant current to the LED modules 13.

In this embodiment, in the same frame time, the control module 12 outputs the electrical signals to different LED modules 13 through different output terminal groups 12a in sequence. Since the control module 12 outputs the electrical signals in sequence by delaying a setting time, it can prevent all of the LED modules 13 from being turned on at a same time and can reduce an instantaneous current load of the LED panel 100 and an instantaneous voltage drop to maintain normal operations of the control module 12.

Optionally, the LED panel may be an LED display panel or a backlight panel.

Optionally, the clock generation module 11 and the control module 12 are integrated into a part of a chip, and the chip receives a constant voltage. When the control module 12 outputs the electrical signals to different LED modules 13 in sequence by delaying the setting time, the LED modules 13 are turned on in sequence, which reduces an instantaneous current load of the LED modules 13, thereby reducing an instantaneous drop amount of the constant voltage for maintaining normal operations of the chip.

Optionally, the clock generation module 11 may be an oscillator.

Optionally, the control module 12 includes a logic control unit 12b and a plurality of conversion units 12c. The logic control unit 12b is connected to the clock generation module 11.

The logic control unit 12b includes a plurality of second output terminals 122, and at least one of the second output terminals 122 is correspondingly connected to one of the conversion units 12c. Each of the conversion units 12c is correspondingly connected to one of the output terminal groups 12a.

Each of the conversion units 12c includes at least one conversion submodule 123. The at least one conversion submodule 123 is correspondingly connected to the at least one first output terminal 121 by one to one.

The logic control unit 12b is configured to output digital signals to the conversion units 12c through the at least one of the second output terminals 122 in the same frame time according to the clock signal.

The conversion units 12c are configured to convert the digital signals into the electrical signals and output the electrical signals to the LED modules 13 through the at least one first output terminal 121 of each of the output terminal groups 12a.

Specifically, the at least one conversion submodule 123 of each of the conversion units 12c are configured to convert the digital signals into the electrical signals and output the electrical signals to the LED modules 13 through the at least one first output terminal 121 of each of the output terminal groups 12a.

In this embodiment, each of the output terminal groups 12a includes one first output terminal 121, and each of the conversion units 12c includes one conversion submodule 123. Therefore, each of the second output terminals 122 of the logic control unit 12b is correspondingly connected to the conversion submodule 123 of each of the conversion units 12c, and the conversion submodule 123 of each of the conversion units 12c is correspondingly connected to one of the LED modules 13 through the first output terminal 121 of each of the output terminal groups 12a to allow the logic control unit 12b to turn on the LED modules 13 in sequence.

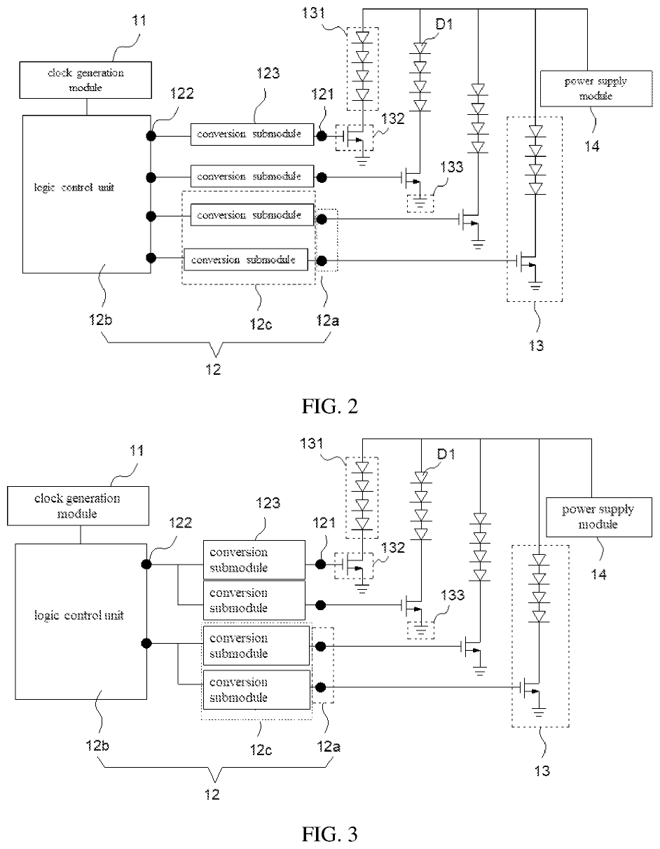

In some embodiments, referring to FIG. 2, each of the output terminal groups 12a may include a plurality of first output terminals 121, for example, two first output terminals 121. Each of the conversion units 12c may include a plurality of conversion submodules 123, for example, two conversion submodules 123. Therefore, each of the second output terminals 122 of the logic control unit 12b is correspondingly connected to one of the conversion submodules 123, and each of the conversion submodules 123 is correspondingly connected to one of the LED modules 13 through one of the first output terminals 121. The logic control unit 12b outputs signals twice in succession, and outputs two signals at a same time in each time to turn on two of the LED modules 13 at the same time.

In some embodiments, referring to FIG. 3, each of the output terminal groups 12a may include the plurality of first output terminals 121, for example, two first output terminals 121. Each of the conversion units 12c may include the plurality of conversion submodules 123, for example, two conversion submodules 123. Therefore, each of the second output terminals 122 of the logic control unit 12b is correspondingly connected to two of the conversion submodules 123, and each of the conversion submodules 123 is correspondingly connected to one of the LED modules 13 through one of the first output terminals 121. The logic control unit 12b outputs the signals twice in succession, and outputs one signal in each time to turn on two of the LED modules 13 at the same time.

Optionally, in this embodiment, in a turned-on stage of the LED panel 100, the logic control unit 12b outputs the digital signals to a next conversion unit 12c in sequence by delaying the setting time.

Optionally, the setting time ranges from 100 ns to 2500 ns, for example, 100 ns, 500 ns, 1000 ns, 2000 ns, or 2500 ns. This setting ensures that the instantaneous current load of the LED panel 100 is small, thereby maintaining the normal operations of the control module 12.

Optionally, the logic control unit 12b outputs the digital signals to different conversion units 12c in sequence by delaying a same setting time or different setting times.

In this embodiment, the logic control unit 12b outputs the digital signals to different conversion units 12c in sequence by delaying the same setting time. For example, the logic control unit 12b outputs the digital signals to different conversion units 12c in sequence by delaying 100 ns, that is, after the logic control unit 12b outputs a digital signal to one of the conversion units 12c at a first time, the logic control unit 12b outputs another digital signal to the next conversion unit 12c at a time interval of 100 ns.

In some embodiments, the logic control unit 12b outputs the digital signals to different conversion units 12c in sequence by delaying different setting times. For example, the logic control unit 12b outputs the digital signals to different conversion units 12c in sequence by delaying 100 ns, 200 ns, and 300 ns, that is, after the logic control unit 12b outputs a digital signal to one of the conversion units 12c at a first time, the logic control unit 12b outputs another digital signal to the next conversion unit 12c after 100 ns at a second time, the logic control unit 12b outputs yet another digital signal to a subsequent conversion unit 12c after 200 ns at a third time, and the logic control unit 12b outputs yet another digital signal to another subsequent conversion unit 12c after 300 ns at a fourth time.

Each of the LED modules 13 includes an LED device group 131, a switching device 132, and a ground wire 133. The at least one conversion submodule 123 is connected to a control terminal of the switching device 132 by the at least one first output terminal 121, an input terminal of the switching device 132 is connected to the LED device group 131, and an output terminal of the switching device 132 is connected to the ground wire 133.

In this embodiment, the LED device group 131 includes a plurality of LED devices D1. The ground wire 133 of each of the LED modules 13 is connected to each other. In some embodiments, ground wires 133 of any two LED modules 13 may be independent to each other.

Optionally, the switching device 132 is a constant-current field effect transistor.

In this embodiment, referring to FIG. 1, it is assumed that there are four conversion units 12c, each of the conversion units 12c includes one conversion submodule 123, and there are four LED modules 13 as well. Four second output terminals 122 of the logic control unit 12b are correspondingly connected to four conversion submodules 123 by one to one, respectively, and the four conversion submodules 123 are correspondingly connected to the four LED modules 13 through the first output terminals 121 by one to one, respectively.

When a current is input to the LED modules 13, a first conversion submodule 123 outputs a signal to turn on a first LED module 13, and the current is transmitted to a ground wire 133 of the first LED module 13 after passing through an LED device group 131 and a switching device 132 of the first LED module 13. It is assumed that a resistance of the ground wire 133 is 10Ω and the current passing through the switching device 132 is constantly 10 mA, then a voltage generated by the ground wire 133 is 0.1 V.

Since the four conversion submodules 123 transmit the signals to the four LED modules 13 corresponding thereto in sequence, the four LED modules 13 are turned on in sequence. Therefore, in the same frame time, an instantaneous voltage generated by ground wires 133 of the four LED modules 13 is 0.1 V.

However, four LED modules 13 in current technology are turned on at a same time, so ground wires 133 thereof will generate an instantaneous voltage of 0.4 V, causing a higher instantaneous voltage drop.

Therefore, this embodiment using the control module 12 to turn on the LED modules 13 in sequence has an effect of reducing the instantaneous voltage drop, and can prevent a voltage provided to the clock generation module 11 and the control module 12 from being greatly reduced instantaneously, thereby preventing the clock generation module 11 and the control module 12 from being unable to maintain normal operations.

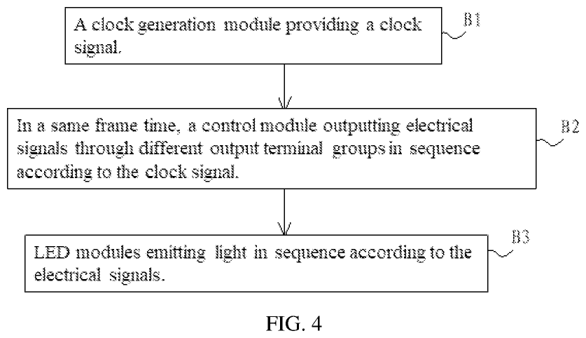

Referring to FIGS. 1 and 4, an embodiment of the present disclosure further provides a driving method of the LED panel. The driving method is configured to drive the LED panel 100 in the embodiments above. The LED panel 100 includes the clock generation module 11, the control module 12, and the plurality of LED modules 13. The control module 12 is connected to the clock generation module 11. The control module 12 includes the plurality of output terminal groups 12a. Each of the output terminal groups 12a includes the at least one first output terminal 121, and each of the LED modules 13 is correspondingly connected to the at least one first output terminal 121 by one to one.

The control module includes the logic control unit 12b and the plurality of conversion units 12c, and each of the conversion units 12c includes the at least one conversion submodule 123.

The logic control unit 12b is connected to the clock generation module 11. The logic control unit 12b includes the plurality of second output terminals 122, the at least one of the second output terminals 122 is correspondingly connected to one of the conversion units 12c, and each of the conversion units 12c is correspondingly connected to one of the output terminal groups 12a. The at least one conversion submodule 123 is correspondingly connected to the at least one first output terminal 121 by one to one.

The at least one conversion submodule 123 is connected to the control terminal of the switching device 132 by the at least one first output terminal 121, the input terminal of the switching device 132 is connected to the LED device group 131, and the output terminal of the switching device 132 is connected to the ground wire 133.

The driving method includes following steps:
step B1: the clock generation module 11 providing the clock signal;
step B2: in the same frame time, the control module 12 outputting the electrical signals through different output terminal groups 12a in sequence according to the clock signal; and
step B3: the LED modules 13 emitting light in sequence according to the electrical signals.

The driving method of the LED panel in this embodiment using the control module 12 to turn on the LED modules 13 in sequence has the effect of reducing the instantaneous voltage drop, and can prevent the voltage provided to the clock generation module 11 and the control module 12 from being greatly reduced instantaneously, thereby preventing the clock generation module 11 and the control module 12 from being unable to maintain normal operations. The driving method of the LED panel in this embodiment will be described in detail below.

The step B1: the clock generation module 11 providing the clock signal. Optionally, the clock generation module 11 is the oscillator. Then proceed to the step B2.

The step B2: in the same frame time, the control module 12 outputting the electrical signals through different output terminal groups 12a in sequence according to the clock signal.

The step B2 includes following steps:

step B21: in the same frame time, the logic control unit 12b outputting the digital signals to the conversion units 12c through the at least one of the second output terminals 122 according to the clock signal; and

step B22: the conversion units 12c converting the digital signals into the electrical signals and outputting the electrical signals to the LED modules 13 through the at least one first output terminal 121 of each of the output terminal groups 12a.

Optionally, the step B21 includes: in the same frame time of the turned-on stage of the LED panel 100, the logic control unit 12b outputting the digital signals to the next conversion unit 12c in sequence according to the clock signal by delaying the setting time.

Optionally, the setting time ranges from 100 ns to 2500 ns, for example, 100 ns, 500 ns, 1000 ns, 2000 ns, or 2500 ns. This setting ensures that the instantaneous current load of the LED panel 100 is small, thereby maintaining the normal operations of the control module 12.

Optionally, the step B21 includes: the logic control unit 12b outputting the digital signals to different conversion units 12c in sequence according to the clock signal by delaying the same setting time or different setting times.

For example, the logic control unit 12b outputs the digital signals to different conversion units 12c in sequence by delaying 100 ns, that is, after the logic control unit 12b outputs the digital signal to one of the conversion units 12c at the first time, the logic control unit 12b outputs another digital signal to the next conversion unit 12c at the time interval of 100 ns.

For another example, the logic control unit 12b outputs the digital signals to different conversion units 12c in sequence by delaying 100 ns, 200 ns, and 300 ns, that is, after the logic control unit 12b outputs the digital signal to one of the conversion units 12c at the first time, the logic control unit 12b outputs another digital signal to the next conversion unit 12c after 100 ns at the second time, the logic control unit 12b outputs yet another digital signal to the subsequent conversion unit 12c after 200 ns at the third time, and the logic control unit 12b outputs yet another digital signal to another subsequent conversion unit 12c after 300 ns at the fourth time.

Then proceed to the step B3.

The step B3: the LED modules 13 emitting light in sequence according to the electrical signals.

Optionally, if the switching device 132 of each of the LED modules 13 is an N-type metal-oxide-semiconductor (MOS) tube, when the electrical signals are at a high electrical potential, the N-type MOS tube is turned on. If the switching device 132 of each of the LED modules 13 is a P-type MOS tube, when the electrical signals are at a low electrical potential, the P-type MOS tube is turned on.

That is, the switching device 132 is turned on after receiving a voltage signal, thereby allowing the LED device group 131 to emit light.

In summary, it is assumed that there are four conversion units 12c, each of the conversion units 12c includes one conversion submodule 123, and there are four LED modules 13 as well. The four second output terminals 122 of the logic control unit 12b are correspondingly connected to the four conversion submodules 123 by one to one, respectively, and the four conversion submodules 123 are correspondingly connected to the four LED modules 13 through the first output terminals 121 by one to one, respectively.

Then in the steps B2 and B3, in the same frame time, the LED modules 13 receive the constant voltage, after that, the logic control unit 12b outputs the digital signals to the first conversion submodule 123 according to the clock signal, the first conversion submodule 123 converts the digital signals into the electrical signals and turns on the first LED module 13, and the current is transmitted to the ground wire 133 of the first LED module 13 after passing through the LED device group 131 and the switching device 132 of the first LED module 13. It is assumed that the resistance of the ground wire 133 is 10Ω and the current passing through the switching device 132 is constantly 10 mA, then the voltage generated by the ground wire 133 is 0.1 V.

Then the logic control unit 12b outputs the digital signals to a second conversion submodule 123 by delaying the setting time, for example 100 ns, and the second conversion submodule 123 converts the digital signals into the electrical signals and turns on a second LED module 13.

Then the logic control unit 12b outputs the digital signals to a third conversion submodule 123 by delaying 100 ns again, and the third conversion submodule 123 converts the digital signals into the electrical signals and turns on a third LED module 13.

At last, the logic control unit 12b outputs the digital signals to a fourth conversion submodule 123 by delaying 100 ns again, and the fourth conversion submodule 123 converts the digital signals into the electrical signals and turns on a fourth LED module 13.

Thus, a driving process of this embodiment is completed.

The LED panel and the driving method thereof provided by the embodiments of the present disclosure are described in detail above. Specific examples are used herein to explain the principles and implementation of the present disclosure. The descriptions of the above embodiments are only used to help understand the method of the present disclosure and its core ideas; meanwhile, for those skilled in the art, the range of specific implementation and application may be changed according to the ideas of the present disclosure. In summary, the content of the specification should not be construed as causing limitations to the present disclosure.

What is claimed is:

1. A light-emitting diode (LED) panel, comprising:
a clock generation module configured to provide a clock signal;
a control module connected to the clock generation module, wherein the control module comprises a plurality of output terminal groups, each of the output terminal groups comprises at least one first output terminal, and the control module outputs electrical signals through different output terminal groups in sequence in a same frame time according to the clock signal; and
a plurality of LED modules, wherein each of the LED modules is correspondingly connected to the at least one first output terminal by one to one, and the LED modules are configured to emit light in sequence according to the electrical signals.

2. The LED panel according to claim 1, wherein the control module comprises a logic control unit and a plurality of conversion units, and each of the conversion units comprises at least one conversion submodule;
the logic control unit is connected to the clock generation module and comprises a plurality of second output terminals, at least one of the second output terminals is correspondingly connected to one of the conversion units, each of the conversion units is correspondingly connected to one of the output terminal groups, and the at least one conversion submodule is correspondingly connected to the at least one first output terminal by one to one;
the logic control unit is configured to output digital signals to the conversion units through the at least one of the second output terminals in the same frame time according to the clock signal; and
the conversion units are configured to convert the digital signals into the electrical signals and output the electrical signals to the LED modules through the at least one first output terminal.

3. The LED panel according to claim 2, wherein each of the output terminal groups comprises one first output terminal, each of the conversion units comprises one conversion submodule, each of the second output terminals of the logic control unit is correspondingly connected to the conversion submodule of each of the conversion units, and the conversion submodule of each of the conversion units is correspondingly connected to one of the LED modules through the first output terminal of each of the output terminal groups.

4. The LED panel according to claim 2, wherein each of the output terminal groups comprises a plurality of first output terminals, each of the conversion units comprises a plurality of conversion submodules, each of the second output terminals of the logic control unit is correspondingly connected to one of the conversion submodules, and each of the conversion submodules is correspondingly connected to one of the LED modules through one of the first output terminals.

5. The LED panel according to claim 2, wherein each of the output terminal groups comprises a plurality of first output terminals, each of the conversion units comprises a plurality of conversion submodules, each of the second output terminals of the logic control unit is correspondingly connected to the conversion submodules, and each of the conversion submodules is correspondingly connected to one of the LED modules through one of the first output terminals.

6. The LED panel according to claim 2, wherein in a turned-on stage of the LED panel, the logic control unit outputs the digital signals to a next conversion unit in sequence by delaying a setting time.

7. The LED panel according to claim 6, wherein the setting time ranges from 100 ns to 2500 ns.

8. The LED panel according to claim 6, wherein the logic control unit outputs the digital signals to different conversion units in sequence by delaying a same setting time or different setting times.

9. The LED panel according to claim 2, wherein each of the LED modules comprises an LED device group, a switching device, and a ground wire, the at least one conversion submodule is connected to a control terminal of the switching device by the at least one first output terminal, an input terminal of the switching device is connected to the LED device group, and an output terminal of the switching device is connected to the ground wire.

10. The LED panel according to claim 9, wherein the switching device is a constant-current field effect transistor.

11. The LED panel according to claim 1, further comprising a power supply module connected to an input terminal of each of the LED modules.

12. A driving method of a light-emitting diode (LED) panel, wherein the LED panel comprises a clock generation module, a control module, and a plurality of LED modules, the control module is connected to the clock generation module and comprises a plurality of output terminal groups, each of the output terminal groups comprises at least one first output terminal, and each of the LED modules is correspondingly connected to the at least one first output terminal by one to one; the driving method comprising following steps:
step B1: the clock generation module providing a clock signal;
step B2: in a same frame time, the control module outputting electrical signals through different output terminal groups in sequence according to the clock signal; and
step B3: the LED modules emitting light in sequence according to the electrical signals.

13. The driving method of the LED panel according to claim 12, wherein the control module comprises a logic control unit and a plurality of conversion units, and each of the conversion units comprises at least one conversion submodule;
the logic control unit is connected to the clock generation module and comprises a plurality of second output terminals, at least one of the second output terminals is correspondingly connected to one of the conversion units, each of the conversion units is correspondingly connected to one of the output terminal groups, and the at least one conversion submodule is correspondingly connected to the at least one first output terminal by one to one;
wherein the step B2 comprises following steps:
step B21: in the same frame time, the logic control unit outputting digital signals to the conversion units through the at least one of the second output terminals according to the clock signal; and
step B22: the conversion units converting the digital signals into the electrical signals and outputting the electrical signals to the LED modules through the at least one first output terminal.

14. The driving method of the LED panel according to claim 13, wherein each of the output terminal groups comprises one first output terminal, each of the conversion units comprises one conversion submodule, each of the second output terminals of the logic control unit is correspondingly connected to the conversion submodule of each of the conversion units, and the conversion submodule of each of the conversion units is correspondingly connected to one of the LED modules through the first output terminal of each of the output terminal groups.

15. The driving method of the LED panel according to claim 13, wherein the step B21 comprises a following step: in the same frame time of a turned-on stage of the LED panel, the logic control unit outputting the digital signals to a next conversion unit through the at least one of the second output terminals in sequence according to the clock signal by delaying a setting time.

16. The driving method of the LED panel according to claim 15, wherein the setting time ranges from 100 ns to 2500 ns.

17. The driving method of the LED panel according to claim 16, wherein the step B21 comprises a following step: the logic control unit outputting the digital signals to different conversion units through the at least one of the second output terminals in sequence according to the clock signal by delaying a same setting time or different setting times.

18. The driving method of the LED panel according to claim 12, wherein each of the LED modules comprises an LED device group, a switching device, and a ground wire, the at least one conversion submodule is connected to a control terminal of the switching device by the at least one first output terminal, an input terminal of the switching device is connected to the LED device group, and an output terminal of the switching device is connected to the ground wire.

19. The driving method of the LED panel according to claim 18, wherein the switching device is a constant-current field effect transistor.

20. The driving method of the LED panel according to claim 12, wherein the LED panel further comprises a power supply module connected to an input terminal of each of the LED modules.
